(19) United States
(12) Patent Application Publication
(10) Pub. No.: US 2010/0207291 A1
(43) Pub. Date: Aug. 19, 2010

(54) Method of Making a Tubular Member

(75) Inventors: Tracee Eidenschink, Wayzata, MN (US); James Feng, Maple Grove, MN (US); Karl A. Jagger, Deephaven, MN (US); Daniel Gregorich, St. Louis Park, MN (US); Leonard B. Richardson, Brooklyn Park, MN (US); Timothy J. Mickley, Elk River, MN (US); James Lee Shippy, Plymouth, MN (US); Daniel J. Horn, Shoreview, MN (US); John J. Chen, Plymouth, MN (US); Thomas J. Holman, Princeton, MN (US); David McMorrow, Galway City (IE); Jon Kolbrek, Maple Grove, MN (US); Horng-Ban Lin, Maple Grove, MN (US)

Correspondence Address: VIDAS, ARRETT & STEINKRAUS, P.A., SUITE 400, 6640 SHADY OAK ROAD, EDEN PRAIRIE, MN, 55344, US

(73) Assignee: BOSTON SCIENTIFIC SCIMED, INC., Maple Grove, MN (US)

(21) Appl. No.: 12/370,724

(22) Filed: Feb. 13, 2009

(51) Int. Cl. B29D 23/00; B21C 23/08

(52) U.S. Cl. 264/209.1; 72/264

(57) ABSTRACT

A method of producing a tubular member which includes providing at least one micro-extruder configured to extrude at least one material and providing a surface configured to accept the material extruded from the micro-extruder.

### CROSS-REFERENCE TO RELATED APPLICATIONS

Not Applicable

### STATEMENT REGARDING FEDERALLY SPONSORED RESEARCH

Not Applicable

### BACKGROUND OF THE INVENTION

1. Field of the Invention

The present invention is directed to methods of producing medical devices such as catheters, balloons, and stents. At least some embodiments of the invention are directed to methods of applying coatings, such as therapeutic agents, directly to the surface of a medical device with extreme precision.

2. Description of the Related Art

Percutaneous transluminal angioplasty (PTA), including percutaneous transluminal coronary angioplasty (PTCA), is a procedure which is well established for the treatment of blockages, lesions, stenosis, thrombus, etc. present in body lumens, such as the coronary arteries and/or other vessels.

Percutaneous angioplasty makes use of a dilatation balloon catheter, which is introduced into and advanced through a lumen or body vessel until the distal end thereof is at a desired location in the vasculature. Once in position across an afflicted site, the expandable portion of the catheter, or balloon, is inflated to a predetermined size with a fluid at relatively high pressures. By doing so the vessel is dilated, thereby radially compressing the atherosclerotic plaque of any lesion present against the inside of the artery wall, and/or otherwise treating the afflicted area of the vessel. The balloon is then deflated to a small profile so that the dilatation catheter may be withdrawn from the patient's vasculature and blood flow resumed through the dilated artery.

In angioplasty procedures of the kind described above, there may be restenosis of the artery, which either necessitates another angioplasty procedure, a surgical by-pass operation, or some method of repairing or strengthening the area.

To reduce restenosis and strength the area, a physician can implant an intravascular prosthesis for maintaining vascular patency, such as a stent, inside the artery at the lesion. Implantable medical devices such as stents, stent-grafts, expandable frameworks, and similar implantable medical devices, and their delivery systems such as catheter systems of all types are known.

Catheters, balloons, and stents are known to be produced using a wide range of production techniques. More recently stents have been provided with additional coatings or surface modifications to allow the stent to deliver therapeutic agents (drugs, etc.) directly to the site at which the stent is implanted.

There remains a need, however, for innovative and improved methods of producing medical devices, such as catheters, balloons, and stents, such that materials can be placed directly on the surface of a medical device with extreme precision.

The art referred to and/or described above is not intended to constitute an admission that any patent, publication or other information referred to herein is “prior art” with respect to this invention. In addition, this section should not be construed to mean that a search has been made or that no other pertinent information as defined in 37 C.F.R. §1.56(a) exists.

All U.S. patents and applications and all other published documents mentioned anywhere in this application are incorporated herein by reference in their entirety.

Without limiting the scope of the invention a brief summary of some of the claimed embodiments of the invention is set forth below. Additional details of the summarized embodiments of the invention and/or additional embodiments of the invention may be found in the Detailed Description of the Invention below.

A brief abstract of the technical disclosure in the specification is provided for the purposes of complying with 37 C.F.R. 1.72.

### BRIEF SUMMARY OF THE INVENTION

At least one embodiment of the invention is directed to a method of producing a tubular member. The method comprises the step of providing at least one micro-extruder configured to extrude at least one material. The method further comprises the step of providing a mandrel configured to accept the at least one material extruded from the at least one micro-extruder.

In some embodiments the tubular member is a balloon. In at least one embodiment, the tubular member is a catheter.

At least one embodiment of the present invention is directed to a method of constructing a medical device. The method comprises the step of providing at least one micro-extruder configured to extrude at least one material. The method also comprises the step of providing a medical device configured to accept the at least one material extruded from the at least one micro-extruder. The method further comprises the step of extruding the at least one material onto the medical device.

In some embodiments, the medical device is a stent. In at least one embodiment, the medical device is a balloon. In another embodiment, the medical device is a catheter.

These and other embodiments which characterize the invention are pointed out with particularity in the claims annexed hereto and forming a part hereof. However, for further understanding of the invention, its advantages and objectives obtained by its use, reference should be made to the drawings which form a further part hereof and the accompanying descriptive matter, in which there is illustrated and described embodiments of the invention.

### BRIEF DESCRIPTION OF THE SEVERAL VIEWS OF THE DRAWING(S)

A detailed description of the invention is hereafter described with specific reference being made to the drawings.

FIG. 1 is a cross-sectional view of an embodiment of the inventive method wherein a micro-extruder is depositing material onto a mandrel.

FIG. 1A is a plan view of an embodiment of the invention method wherein a micro-extruder is used to deposit material onto a surface in order to form a stent.

FIG. 2 is a side view of a medical device having material deposited onto it by a micro-extruder.

FIG. 3 is a side view of a stent having material deposited onto it by a micro-extruder.

FIG. 4 is a side view of a bifurcated stent having material deposited onto it by a micro-extruder.

FIG. 5 is a cross-sectional view of an embodiment of the invention wherein a micro-extruder is depositing material used to create an electro-active polymer device.

FIG. 6 is a side view of a stent having material deposited onto it by a micro-extruder.

FIG. 7 is a side view of a medical device having material deposited onto it by a micro-extruder.

FIG. 8 is a side view of a folded balloon having material deposited onto it by a micro-extruder.

FIG. 9 is an isometric view of a stent and balloon combination having material deposited onto it by a micro-extruder.

### DETAILED DESCRIPTION OF THE INVENTION

While this invention may be embodied in many different forms, there are described in detail herein specific preferred embodiments of the invention. This description is an exemplification of the principles of the invention and is not intended to limit the invention to the particular embodiments illustrated.

For the purposes of this disclosure, like reference numerals in the figures shall refer to like features unless otherwise indicated.

In at least one embodiment, micro-extruding dispensers use well-controlled positive displacement dispensing that is synchronized with substrate motion as well as dispenser dynamics that sense dispenser height. The dispenser tip is mounted at the end of a cantilever such that its position normal to the drawing surface is flexible. Interaction between a magnet near the dispenser tip and a solenoid allows the pressure to be controlled at a specific value so that the dispenser tip can move normal to the drawing surface while maintaining a constant gap according to the surface topology. One example of a micro-extruding dispenser, or micro-extruder, suitable for use with embodiments of the present invention is the MicroPen® available from Ohmcraft Inc. of Honeoye Falls, N.Y. (www.ohmcraft.com). An embodiment of such a dispenser is detailed in U.S. Pat. No. 4,485,387 to Drumheller, the entire contents of which are incorporated herein by reference.

A typical micro-extrusion setup includes a micro-extruder controlled by a computer for precise material placement. The micro-extruder can have an extrusion orifice with a diameter as small as 25 μm or even smaller. The minimum orifice size is dependent upon the size of the particulate to be extruded, if a particulate laden material is to be extruded. It is generally desirable to use an extrusion orifice at least ten times greater than the particulate size.

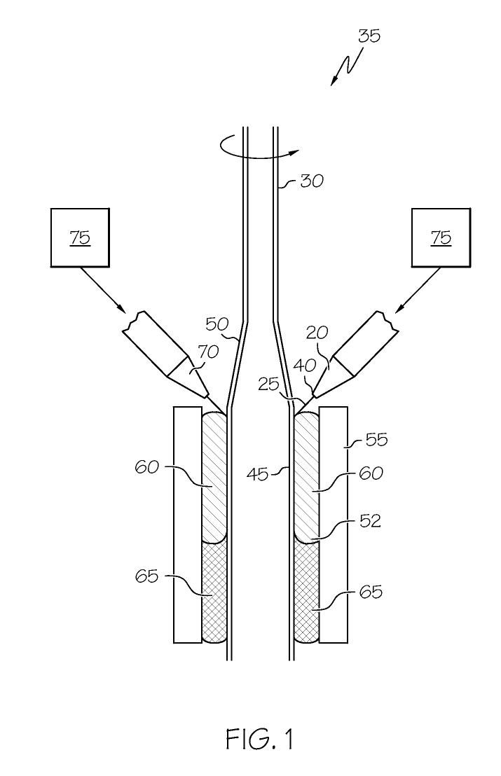

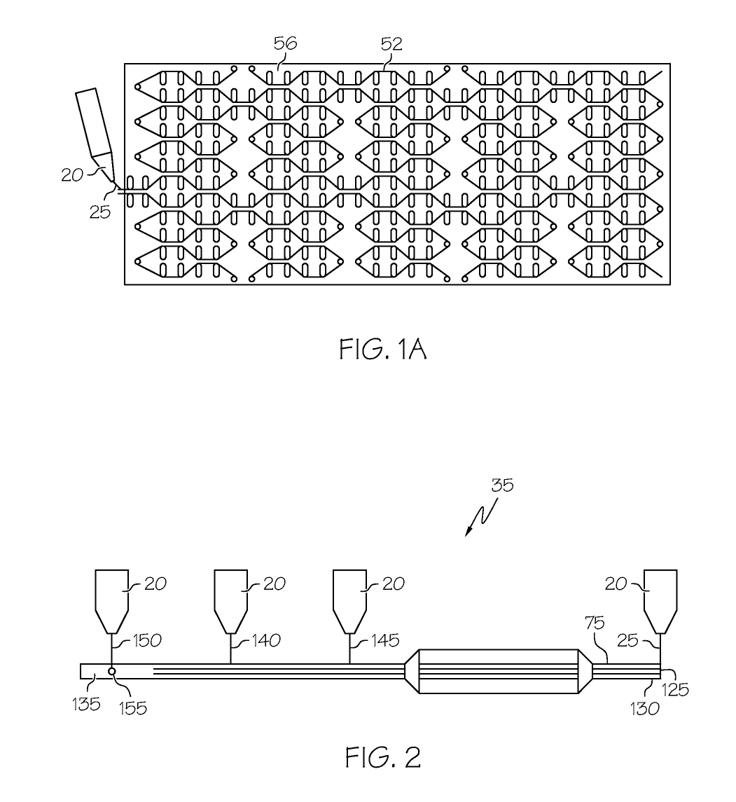

At least one embodiment of the invention is directed towards a method of producing a tubular member, as depicted in FIG. 1. The method comprises the steps of providing at least one micro-extruder 20 configured to extrude at least one material 25, and providing a surface 30 configured to accept the at least one material 25 extruded from the at least one micro-extruder 20. The surface could be a mandrel as well as a substantially horizontal substrate. If a substantially horizontal substrate is used as a surface, the deposited material is rolled or shaped into a tubular member subsequent to deposition. FIG. 1 depicts a dispensing system 35 comprising a first micro-extruder 20 with extrusion orifice 40. The micro-extruder 20 is configured to extrude at least one material 25 through extrusion orifice 40. Also shown in FIG. 1 is a mandrel 30, configured to receive material 25.

In some embodiments, the surface is configured to rotate. In such an embodiment, using a mandrel is desirable. In at least one embodiment, at least a portion of the mandrel is straight, as shown in FIG. 1 at 45. In some embodiments, at least a portion of the mandrel is tapered, as shown at 50.

In at least one embodiment, as the mandrel is rotating, material is extruded onto the mandrel to produce tubular member 52. In some embodiments, a container, such as a cylinder 55, may be disposed about the mandrel in order to limit the maximum thickness of the material on the mandrel.

In at least one embodiment, the tubular member formed by the method is a balloon or balloon pre-form. Depending on the desired characteristics of the balloon, different materials may be used in the extrusion. For example, in some embodiments, a concentrated polymer solution may be used to form a sharp transition of a balloon tube. Solution concentrations of 5% or more by weight are generally desired. Balloon materials that can be included include TPU in THF, Pebax in HFIP, as well as Nylon in Cresol, for example. Also, Poly(p-phenyleneterephthalamide) (PPT) in 100% H₂SO₄ can be used. In solution, PPT is lyotropic and can be extruded at its anisotropic state to have its molecules oriented at the dispenser (pen) moving direction. The molecular chain orientation can be altered upon predetermined direction. Also the orientation direction can be different form layer to layer (any combination between the layers) if multiple layers are applied.

Or, in other embodiments where building up balloon tubing wall thickness more quickly with fewer layers is desirable, a gel system is used with the concentrated solution. In this gel/solution system the solute can be loaded higher than 50%. The gel coated section may be heated above its gel temperature to drive out the solvent, or extracted with volatile solvent. Another coating layer may be applied after the previous coating has dried. The following are non-limiting example of gels that can be used:

### EXAMPLE 1

Poly(vinyl alcohol) in glycerin. In this system, any nano reinforcement materials can be incorporated such as carbon nanotubes, nanofibers, nanoclay, metal nanoparticles, and ceramic nanoparticles, for example. A gel is formed after the solution leaves dispenser.

### EXAMPLE 2

UHMWPE or high MW HDPE in paraffin oil at elevated temperature, and the solution is cooled to room temperature to form gel. The gel is fed to micro-extruding dispenser to form a tube. The gel tube is extracted with hexane to remove the paraffin oil, vacuum dried.

### EXAMPLE 3

Organic/inorganic hybrid polymer in a sol-gel form. The organic precursor of the hybrid is a compound or oligomer that contains both a cross-linkable functional group (e.g., phenylethynyl) and an alkoxysilane group. The inorganic precursor of the hybrid is also an alkoxysilane. Both precursors are mixed with a solvent to form the sol-gel material. The sol-gel material also can be reinforced with nano materials like nanoclay by mixing nanoclay solution into the polymer sol-gel.

In at least one embodiment, the material may be a polymer melt, provided that the polymer melt has good flow characteristics and is stable when exposed to the atmosphere. An example of a polymer melt is any current balloon material such as Pebax, TPU, nylon, and polyester.

In some embodiments, the material may be a polymer dissolved in a suitable solvent, thereby converting it from a solid polymer to a liquid polymer solvent.

In at least one embodiment, the material may be comprised of one or more metals, polymers or combinations thereof that are corrodible so as to dissolve, dissociate or otherwise break down in the body without ill effect. Examples of such materials have been referred to as being degradable, biodegradable, biologically degradable, erodable, bioabsorbable, bioresorbable, and the like, and are hereinafter collectively referred to as being bioabsorbable materials. Examples of bioabsorbable metals include iron and magnesium. Examples of polymer-based bioabsorbable materials include PLGA and polylactic acid.

In at least one embodiment, the tubular member formed by the method is a stent. FIG. 1A depicts micro-extruder 20 configured to extrude a material 25 over a predefined toolpath 56 in order to create a stent 52. This allows fast fabrication and would not require the use of expensive, specialized injections moulds.

In constructing a medical device, it is often desirable to use multiple materials to take advantage of their respective properties. For example, in at least one embodiment, a portion of the medical device may be constructed to be more flexible then an adjacent portion. Referring now to FIG. 1, in some embodiments of the present invention, the at least one micro-extruder 20 is configured to extrude a first material 60 and a second material 65, the first material 60 being different from the second material 65. This configuration achieves short multi-component transition zones, such as between a balloon wall and a distal outer.

In other instances it is desirable to use more than one micro-extruder to construct the medical device. The invention includes at least one embodiment directed to a method which includes a dispensing system 35 having a first micro-extruder 20 and a second micro-extruder 70. This configuration allows multiple delivery points for materials, thereby expediting manufacture. The micro-extruders are controlled by a computer 72 or other controller known to those of ordinary skill in order to ensure precise placement of the material.

In addition to forming balloons, at least one embodiment of the invention is directed towards a method of forming other tubular members such as catheters.

Besides tubular members, the invention includes embodiments of methods directed towards constructing medical devices, as depicted in FIG. 2. In some embodiments the invention is directed towards a method of constructing a medical device 75 comprising the steps of providing at least one micro-extruder 20 configured to extrude at least one material 25; providing a medical device 75 configured to accept the at least one material 25 extruded from the at least one micro-extruder 20; and extruding the at least one material 25 onto the medical device 75.

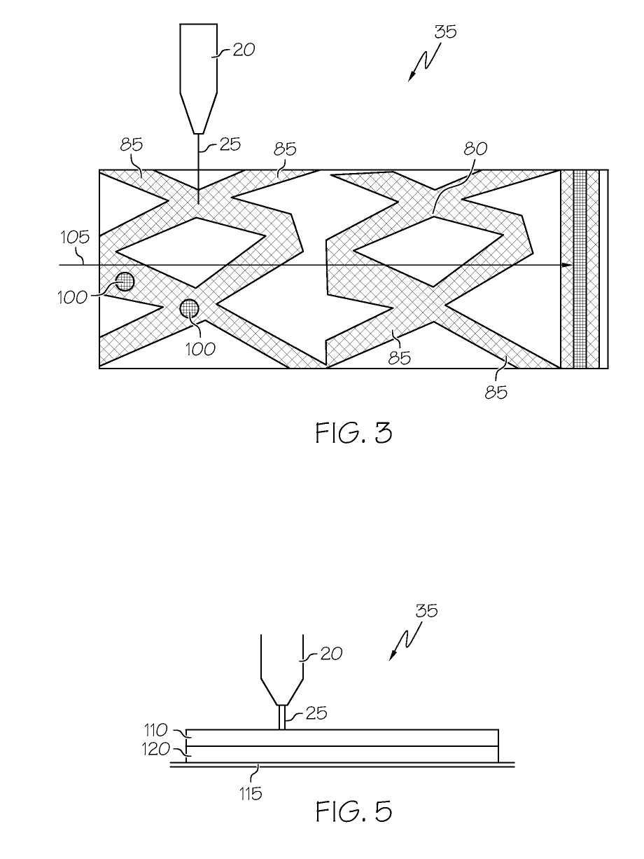

The invention contemplates extruding material onto numerous types of medical devices and their associated components, such as stents, stent-grafts, balloons, catheters, guide wires, sleeves (such as high torque sleeves) or any other medical device or component. For example, as illustrated in FIG. 3 in at least one embodiment, the medical device comprises a stent 80. In some embodiments, the stent 80 comprises stent members 85, the material 25 being extruded onto at least a portion of at least one stent member 85, as shown in FIG. 3. Stent members include struts, connectors, sutures, expansion joints, combinations thereof, or any number of other structures suitable for use in constructing a stent.

The extruded material(s) can be placed on at least a portion of any stent member. By placing the extruded material on only a portion of the stent, a specific region of an artery, vessel, or other body lumen in mammalian anatomy may be treated, without treating adjacent regions.

Additionally, it may be desirable to extrude material on only some stent members and not others because of the characteristics of the stent. For example, in some embodiments, in a stent comprising a plurality of circumferential rings, with adjacent rings being connected by bioabsorbable sutures, the micro-extruder places material such that the sutures remain free of extruded material so as to not interfere with the bioabsorption process. Or, in at least one embodiment, extruded material is only placed on stent members of a bifurcated stent adjacent the carina. One of ordinary skill will recognize that there are a number of embodiments in which material may be selectively placed on only certain areas of a stent, balloon, or catheter.

Whether placing the extruded material onto a stent, stent-graft, balloon, catheter, guide wire, high torque sleeve, or any other medical device or component, the micro-extruder simplifies manufacturing. Using the micro-extruder eliminates the need to coat the entire medical device in the material and wait for the material to dry/cure. Coating the entire medical device in the material may in some cases be wasteful or inefficient because oftentimes areas that do not need any coating are coated or because excess coating requires removal before the device can be used. Furthermore, specific placement of material allows control over deposition thicknesses, thereby allowing longer (or shorter) time release of the material, depending on the desired characteristic.

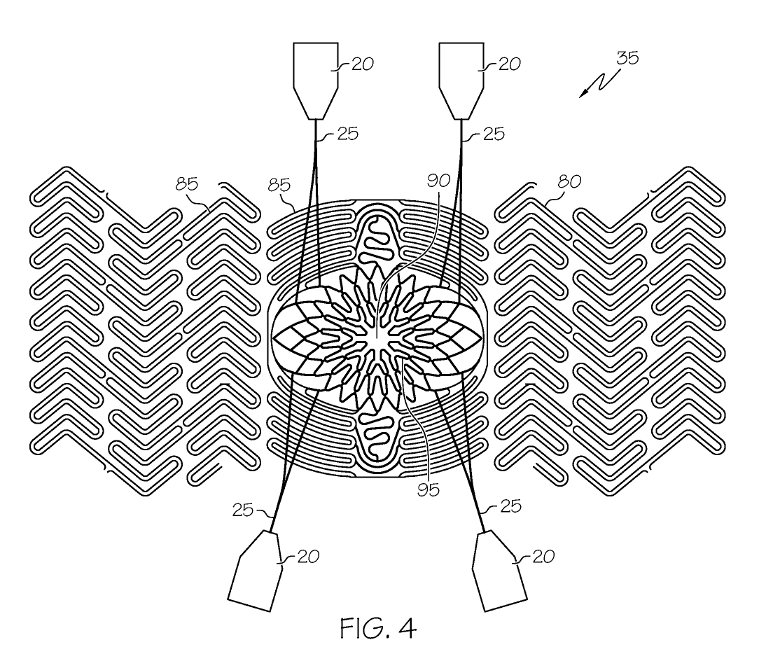

The extruded material may also be placed on bifurcated stents, as illustrated in FIG. 4. Bifurcated stents are well known. In general, a stent 80 comprises a plurality of the interconnected stent members 85 which define a plurality of cells. In a bifurcated stent, at least one of the cells is typically a side opening 90. The side opening 90 is distinguishable because it is shaped differently than the other cells of the stent. In some embodiments, the side opening is larger than the other cells. The extruded material can be placed on any portion of any of the stent members that define the side opening. The side opening may also have a perimeter, on any portion of which the extruded material can be placed. Also, the extruded material can be placed on any portion of any of the stent members which define the first or second branch of the bifurcated stent.

By selectively placing extruded material on a bifurcated stent, restenosis or other arterial conditions can be precisely controlled. For example, restenosis adjacent a vessel's carina can be specifically treated by extruding material, such as one or more therapeutic agents, onto the portion of the stent adjacent the carina. FIG. 4 shows a stent pattern, with a side branch 95, wherein an extruded material is placed on selected stent members.

In constructing a medical device, it may be desirable to ablate or chemically etch predetermined portions of the medical device. For example, in at least one embodiment, grooves can be created for better edge flaring protection. Or, in some embodiments, grooves, channels, holes, or other depressions are made to act as reservoirs for therapeutic agents, as is depicted in FIG. 3. In FIG. 3 micro-extruder 20 is shown depositing a material 25 onto stent members 85 of stent 80 in order to create grooves 100 and channel 105. In at least one embodiment of the invention, the extruded material is an etchant like an acid, base, or other solvent known by those skilled in the art. The etchant may also be a material that chemically ablates portions of the stent members, or portions of other medical devices.

In another embodiment, the first micro-extruder, or a second micro-extruder, delivers the therapeutic agent directly to the portion of the device that was just etched away. For example, in FIG. 3 grooves 100 and channel 105 are filled with therapeutic agent(s) after ablation. Often the agent will be in the form of a coating or other layer (or layers) of material placed on a surface region of the stent, which is adapted to be released at the site of the stent's implantation or areas adjacent thereto. In still another embodiment, alternating layers of therapeutic agents are deposited by the micro-extruders on stent members or other portions of medical devices.

A therapeutic agent may be a drug or other pharmaceutical product such as non-genetic agents, genetic agents, cellular material, etc. Some examples of suitable non-genetic therapeutic agents include but are not limited to: anti-thrombogenic agents such as heparin, heparin derivatives, vascular cell growth promoters, growth factor inhibitors, Paclitaxel, etc. Where an agent includes a genetic therapeutic agent, such a genetic agent may include but is not limited to: DNA, RNA and their respective derivatives and/or components; hedgehog proteins, etc. Where a therapeutic agent includes cellular material, the cellular material may include but is not limited to: cells of human origin and/or non-human origin as well as their respective components and/or derivatives thereof. Where the therapeutic agent includes a polymer agent, the polymer agent may be a polystyrene-polyisobutylene-polystyrene triblock copolymer (SIBS), polyethylene oxide, silicone rubber and/or any other suitable substrate.

Another embodiment of the invention provides for delivery of an electro-active polymer (EAP) by the micro-extruder. Electro-active polymer theory and use are described in detail in U.S. Pat. No. 7,128,707, the entire contents of which being incorporated herein by reference. Using current methods to construct an electro-active polymer device, a substrate with a surface that is 100% conductive is often the starting material. Current methods then typically involve a secondary process in which a portion of the conductive surface is masked, or in which a portion of the EAP material is inactivated. In this manner, unique surfaces with the desired electrical characteristics are created.

In at least one embodiment of the invention, the process steps of creating an EAP device are reduced. Using a micro-extruder to place EAP material, as in an embodiment of the invention, allows tight control of the unique circuitry without the need for the step of inactivation or masking. For example, as illustrated in FIG. 5, EAP material 110 is deposited on a substrate 115 by a micro-extruder 20 to create specific EAP circuits, rather than depositing EAP material and then inactivating large portions to produce the desired EAP circuit. Alternatively, a micro-extruder is used to deposit conductive material in various unique and fine patterns on a substrate, rather than using a conductive sheet and masking large portions of it to create the desired conductive pathways.

As well as depositing the EAP material 110, the micro-extruder 20 is used to deposit the conductive adhesion layer 120 that is used for good adhesion of the electro-active polymer 110 to the conductive substrate 115 in the formation of EAP devices. For example, gold splutter is deposited on the substrate 115 by the micro-extruder 20 to ensure good contact between materials.

As mentioned above, embodiments of the invention are also directed to constructing catheters. In some embodiments, micro-extrusion is used to reinforce the distal tip of a catheter. As catheters track around bends in tortuous anatomy, “fish mouthing” may occur. Fish mouthing is an undesirable condition wherein the normally circular opening at the distal tip of the catheter deforms, creating an elliptical opening which may impede movement along a guidewire. Extruding a reinforcing ring adjacent to the catheter's distal tip results in resistance to fish mouthing.

The micro-extruder is also be used to provide or enhance electrical characteristics. As illustrated in FIG. 2, in at least one embodiment, the micro-extruder 20 is used to apply sensor electrodes 125, or other conductive material, adjacent the distal catheter tip 130 and/ or the proximal catheter tip 135, if desired.

In some embodiments, the micro-extruder 20 is used to deposit conductive material 140 on the catheter, or other medical device, like in FIG. 2. The conductive material 140 is then insulated by using a micro-extruder 20 to cover it with a nonconductive material 145 in a subsequent deposition, or with the same micro-extruder if it is configured to dispense two or more materials. In this manner, alternating layers of conductive and nonconductive layers are created by a single micro-extruder or multiple micro-extruders. The micro-extruder is used to place material on any part of the catheter including, but not limited to, the inner, outer, manifold, and port. The material can be gold, silver, platinum, or other metals as well as conductive polymers containing such metals. The micro-extruder allows electrical pathways to be easily created on the medical device.

In an example of such an embodiment, separate electrical pathways are deposited by the micro-extruders to the catheter's distal seal and the proximal seal, both seals constructed of EAP. Another pathway is created to act as the counter electrode(s) need for EAP activation. All pathways contain nonconductive material deposited by the micro-extruders.

In another example of such an embodiment, coils are deposited by the micro-extruders. A heat source then provides heat to the coils, thus enabling the temperature change needed for a shape memory polymer or alloy to change shape or material properties.

In still another example of such an embodiment, the coil deposited by the micro-extruder is designed to burn through upon receiving the heat from the heat source. Such a design is useful in releasing a Guglielmi Detachable Coil (GDC) for embolizing aneurysms, treating endovascular occlusions, or forming occlusions in mammalian anatomy.

In at least one embodiment, the method includes the step of extruding any type of material that can be used as a marker, as depicted in FIG. 2. The material could be colored, textured, or otherwise designed to distinguish it from surrounding areas of the device. For example, the micro-extruder 20 deposits a marker material 150 such as color adjacent a catheter port 155 to improve the loading of a guidewire. Or, warning marks are placed at specific locations proximal to a catheter port.

In at least one embodiment, micro-extruders are also used for the deposition of a marker material 150 like a radiopaque material. It is often desirable to use material detectable by imaging modalities such as X-Ray, MRI, ultrasound, etc, such as a radiopaque material, in the construction of a medical device. Radiopaque materials are known and are used with implantable medical devices and their delivery systems. Radiopaque materials are used as markers to align delivery systems or devices within the body. In some embodiments, the delivery system or other portion of the assembly may include one or more areas, bands, coatings, members, etc. that is (are) radiopaque. In some embodiments at least a portion of the stent and/or adjacent assembly is at least partially radiopaque. FIG. 6 depicts an embodiment of a micro-extruder 20 depositing marker material 150, namely a radiopaque material, to stent members 85 of stent 80. Deposition of the radiopaque material results in a portion 175 that is at least partially radiopaque.

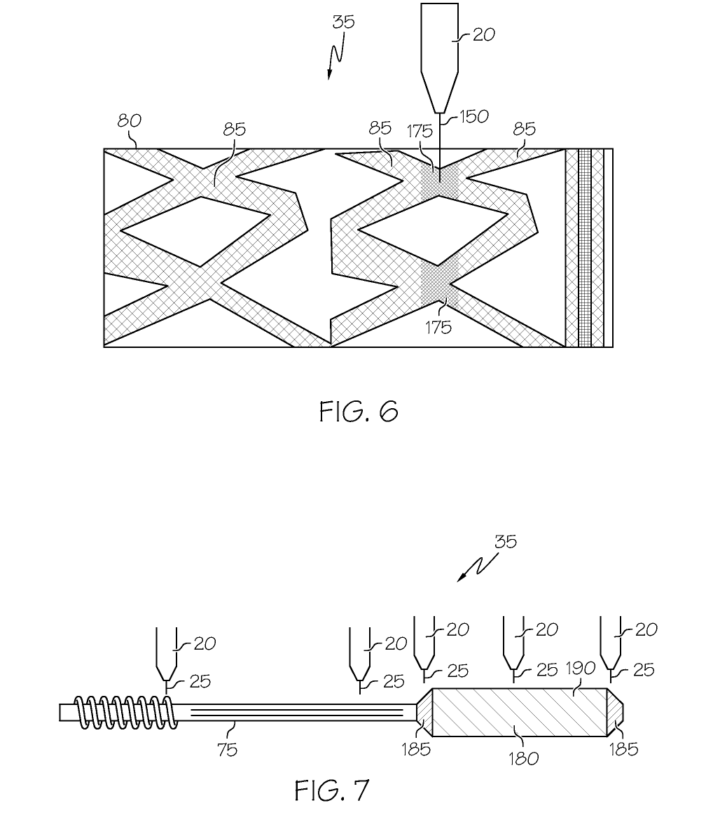

The invention further includes embodiments directed towards balloons. In at least one embodiment, depicted in FIG. 7, the medical device comprises an expandable balloon 190 and the method further comprises the step of extruding the at least one material 25 onto at least a portion of the balloon 190. The material 25 may be placed on the cones 185 as well as on the balloon body 190. In some embodiments, characteristics such as stiffness of the balloon can be controlled by selectively extruding material in desired regions.

In some embodiments, the micro-extruder is used to deposit material, for example a polymer, for edge protection of a stent, or for stent securement on the leading and/or trailing edges of a balloon. In at least one embodiment, the material is placed on a folded balloon 190, as illustrated in FIG. 8. Both the balloon 190 and the stent 80 have proximal ends 195 and distal ends 200. The method comprises the steps of disposing the stent 80 about the balloon 190; folding at least a portion of the proximal end 195 of the balloon 190 over the proximal end 195 of the stent 80 and/or folding at least a portion of the distal end 200 of the balloon over the distal end 200 of the stent 80; and extruding the at least one material 25 onto at least one of the folded portion of the proximal balloon end and the folded portion of the distal balloon end. In this manner the edges of the stent are protected until just prior to deployment.

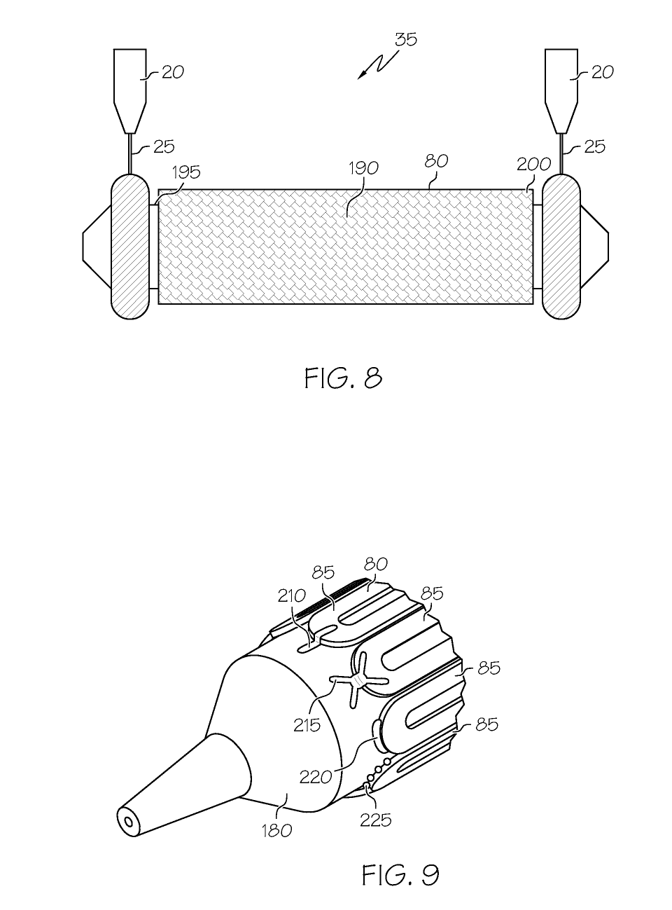

In another embodiment, the micro-extruder is used to dispense a material onto a balloon in order to secure the stent to the balloon. FIG. 9 is an isometric view depicting several non-limiting embodiments of dispensed material, referred to hereafter as stitches, to secure stent 80 to balloon 190.

In FIG. 9, stitch 210 is a line of dispensed material. It travels from the top of the stent member 85, across the end of the stent member 85, and then to the surface of balloon 190. Multiple passes of the micro-extruder can be performed in order to vary the thickness and/or width of the stitch 210. Stitch 215, as shown in FIG. 9, is an “X” pattern. The stitch 215 pattern can be used if the stent-balloon combination requires additional adhesion. Stitch 220 is a fillet that contacts the end of the stent member 85 and the surface of the balloon 190. Stitch 220 enables adhesion while eliminating protrusions over the surface of the stent member 80. Lastly, stitch 225 is a series of droplets of dispensed material. Stitch 225 is similar to stitch 220 in that it eliminates protrusions over the stent member surface, but stitch 225 allows the droplet size to be varied to control particulate release. It should be noted that combinations of these stitches can be applied over the stent for any reason, such as dispersing therapeutic agents or adhesion. It should also be noted that the stitches can be deposited anywhere along the stent-balloon interface.

There are numerous other applications of the methods of the inventions. In some embodiments, the extruded material may be a masking material, placed onto portions of the stent members (or portions of other medical devices), prior deposition of an etchant, to protect portions of the structure from the etchant.

In another embodiment, the micro-extruder can be used to apply a lubricious coating or therapeutic agent(s) to portions of a balloon catheter, stent, or other medical device.

In at least one embodiment, the method includes multiple coatings or layers. Typically a volatile solvent is used because it dries quickly and has minimum interference with an under-layer when multiple coating processes are used.

Because of the control of the micro-extruder, the coating or agent can be applied to spiral regions of the catheter, to conical regions such as on the balloon, or on striped portions of the catheter shaft, or combinations thereof, like in FIG. 7.

In at least one embodiment, the micro-extruder further comprises a curing mechanism, thereby allowing extrusion and curing to occur nearly simultaneously.

In another embodiment, the micro-extruder can dispense collagen or a polymer pattern on an ePTFE graft or valve leaflet material for strength enhancement.

In still another embodiment, the micro-extruder further comprises a wire dispenser. Thus, the micro-extruder can be depositing an adhesive while also dispensing wire onto the adhesive, thereby securing the wire to the medical device. For example, a nitinol wire can be bonded to an ePTFE leaflet.

In some embodiments, the material extruded can be deposited at a catheter port bond for strain relief.

In another embodiment, the extruded material is a lubricant dispensed at specific sites on the catheter for improved sock retraction.

In still another embodiment, the extruded material is an elastic material placed on the balloon to promote re-wrap.

In some embodiments, the micro-extruder is used to create a failure point on the balloon by applying a solvent in a pattern at a predetermined location.

In still another embodiment, the micro-extruder is used to dispense adhesive material for bonding together medical device structures. In some embodiments, the bonding is achieved by a two-part adhesive. A first material is dispensed onto one surface to be bonded and a second material is dispensed onto the other surface to be bonded. When the two surfaces are fitted together, the bonding process begins.

In at least one embodiment, the micro-extruder is used to deposit conductive material in order to form a magnetic resonance imaging (MRI) circuit on a stent.

In some embodiments, the micro-extruder is used to deposit conductive material in micro-coils on a stent for inductive uses.

In another embodiment, the micro-extruder is used to deposit conductive material in order to form a microelectromechanical systems (MEMS) antenna for sending and receiving signals.

In still another embodiment, the micro-extruder is used to deposit conductive material in order to form a micro strain gauge on the device.

In at least some embodiments, the micro-extruder is used to deposit photo-masking material.

In at least one embodiment, the micro-extruder is used to write identifying information on the stent or other medical device. For example, the micro-extruder can deposit material on the stent to form a barcode. The barcode could contain product date-code information, identifying the product, date, time, and manufacturing site at which the device was made.

In another embodiment, the micro-extruder is used to apply coatings on bio-absorbable stents to precisely control the degradation of the bio-absorbable portions.

In some embodiments, the micro-extruder is used to apply tacky biomaterial to selected portions of the stent members in order to secure the stent to the balloon.

In another embodiment, the micro-extruder is used to deposit material in patterns on the balloon in order to provide balloon reinforcement.

In at least one embodiment, the material deposited by the micro-extruder is patterned to provide consistent uniform drug release. For example, the micro-extruder places a coating in a basket weave pattern, thereby assuring a uniform and consistent distribution of material.

In some embodiments, the micro-extruder is used to form leads in ear implants, as well as other systems. In another embodiment, the micro-extruder is used to make customized, frequency directed, hearing implants.

In at least one embodiment, the micro-extruder is used to repair nerve damage. The micro-extruder is used to place conductive material directly onto damaged nerve fibers.

In some embodiments, the micro-extruder is used to link eye movement, etc. to mechanical devices.

In some embodiments, the micro-extruder is used to deposit cell-growth promoters, such as TGF, on graft surfaces in controlled patterns. Similarly, the micro-extruder is used to deposit cell-growth inhibitors on graft surfaces in controlled patterns.

In at least one embodiment, the inner diameter of a catheter is coated by inserting a micro-extruder with a nozzle having selective holes and advancing through the inner diameter.

In some embodiments, the micro-extruder is used to deposit wire or fiber in order to create filter wire, grafts, or other mesh structures.

In at least one embodiment, the micro-extruder can be used to create micro-barbs on the surface of the medical device in order to act like hook and latch fasteners. The micro-barbs act like tissue VELCRO®.

In some embodiments, the micro-extruder is used for implanting hair follicles.

In at least one embodiment, the micro-extruder is used for surgical implementation of a lens following cataract surgery.

Another example of a micro-extruding dispenser, or micro-extruder, suitable for use with embodiments of the present invention is the M³D® system available from Optomec® Design Company of Albuquerque, N. Mex. (www.optomec.com). Details of the M³D® system can be found in U.S. Pat. Nos. 7,045,015 and 7,108,894, and U.S. Patent Application Publication Nos. 2005/0163917, 2006/0233953, and 2006/0280866, the entire contents of each being incorporated herein by reference.

The M³D® system provides an aerosol-based direct-write printing method for maskless mesoscale material deposition which allows line widths as thin as approximately 10 microns.

As mentioned above, it may be desirable to place material onto a guide wire. In an intravascular interventional procedure, guide wires are often used to position catheters and other interventional devices in disease lumen. To meet various challenges in accessing the disease lumen, modern guide wires consist of different pieces of materials with different mechanical properties desirable for their performance. Moreover, a hydrophobic or hydrophilic coating is also applied over the guide wire surface to reduce its friction and to improve wire tracking through the vasculature for delivery of a therapeutic device, such as a balloon catheter or a stent.

The technologies currently used to place hydrophobic or hydrophilic coating onto the guide wire surface have little control over the site-specific amount and location of material deposition. As a consequence, the coating materials may get into unintended spaces, such as the small slots of the high-torque-sleeve (HTS) of a DELTA wire, etc. The “spill over” of the coating materials may result in undesirable performance effects, such as unintentional bonding of the HTS to the inner radiopaque coils and stiffening of the guide wire tip.

The M³D® system available from Optomec® Design Company and the MicroPen® available from Ohmcraft Inc. are examples of suitable micro-extruders which offer more control over the material placement, thereby minimizing or eliminating the “spill over” of coating materials into the unintended spaces to ensure coating performance, as well as to enable design of new features for performance enhancement.

In at least one embodiment of the present, a micro-extruder is used to place a hydrophilic coating, a hydrophobic coating, or a combination hydrophilic and hydrophopic coating onto a guide wire. A combination hydrophilic and hydrophopic coating may be desirable because, for example, some physicians perceive that a guide wire tip, either a polymer tip or a HTS tip, coated with a hydrophilic coating may be less safe than a guide wire tip with a hydrophobic coating. In such a case, the micro-extruder technologies would enable the flexibility of applying a combination of hydrophilic and hydrophobic coatings onto the distal end of a guide wire. This can be achieved by a precise placement of a hydrophobic coating onto the wire tip and a precise placement of a hydrophilic coating adjacent to the hydrophobic segment. With this approach, a balance of the wire safety and performance can be achieved.

The above disclosure is intended to be illustrative and not exhaustive. This description will suggest many variations and alternatives to one of ordinary skill in this art. The various elements shown in the individual figures and described above may be combined or modified for combination as desired. All these alternatives and variations are intended to be included within the scope of the claims where the term “comprising” means “including, but not limited to”.

Further, the particular features presented in the dependent claims can be combined with each other in other manners within the scope of the invention such that the invention should be recognized as also specifically directed to other embodiments having any other possible combination of the features of the dependent claims. For instance, for purposes of claim publication, any dependent claim which follows should be taken as alternatively written in a multiple dependent form from all prior claims which possess all antecedents referenced in such dependent claim if such multiple dependent format is an accepted format within the jurisdiction (e.g. each claim depending directly from claim 1 should be alternatively taken as depending from all previous claims). In jurisdictions where multiple dependent claim formats are restricted, the following dependent claims should each be also taken as alternatively written in each singly dependent claim format which creates a dependency from a prior antecedent-possessing claim other than the specific claim listed in such dependent claim below.

This completes the description of the preferred and alternate embodiments of the invention. Those skilled in the art may recognize other equivalents to the specific embodiment described herein which equivalents are intended to be encompassed by the claims attached hereto.

What is claimed is:

1. A method of producing a tubular member comprising the steps of:
providing at least one micro-extruder, the at least one micro-extruder configured to extrude at least one material; and
providing a surface, the surface being either a mandrel or a substantially horizontal substrate, the surface configured to accept the at least one material extruded from the at least one micro-extruder.

2. The method of claim 1, wherein the at least one material is selected from the group consisting of a gel, a polymer melt, a polymer solution, and a metal.

3. The method of claim 1, wherein the at least one material is a bioabsorbable material.

4. The method of claim 1, wherein the at least one micro-extruder is configured to extrude a first material and a second material, wherein the first material is a different material than the second material.

5. The method of claim 1, wherein the tubular member is a balloon.

6. The method of claim 1, wherein the tubular member is a balloon pre-form.

7. The method of claim 1, wherein the tubular member is a catheter.

8. The method of claim 1, wherein the tubular member is a stent.

9. The method of claim 1, further comprising the step of following a predefined toolpath.

10. The method of claim 1, wherein the at least one micro-extruder comprises a first micro-extruder and a second micro-extruder.
